(19) United States
(12) Patent Application Publication
(10) Pub. No.: US 2024/0242479 A1
(43) Pub. Date: Jul. 18, 2024

(54) METHOD FOR CLASSIFYING FAULTS IN A NETWORK TO BE ANALYSED

(71) Applicant: COMMISSARIAT À L'ENERGIE ATOMIQUE ET AUX ENERGIES ALTERNATIVES, Paris (FR)

(72) Inventor: Lucas JALOUSTRE, Grenoble Cedex 09 (FR)

(73) Assignee: COMMISSARIAT À L'ENERGIE ATOMIQUE ET AUX ENERGIES ALTERNATIVES, Paris (FR)

(21) Appl. No.: 18/694,790

(22) PCT Filed: Sep. 19, 2022
(86) PCT No.: PCT/EP2022/075982

§ 371 Date: Mar. 22, 2024

(30) Foreign Application Priority Data
Sep. 23, 2021 (FR) FR2110018

(51) Int. Cl. G06V 10/764; G06T 5/40; G06V 10/60

(52) U.S. Cl. CPC G06V 10/764; G06T 5/40; G06V 10/60; G06T 2207/10056

(57) ABSTRACT

A method comprises providing a digital image of a reference network, showing a first series of periodic patterns; defining a reference pattern from the patterns of the first series; providing a digital image of the network to be analyzed, showing a second series of periodic patterns; computing a correlation coefficient between each pattern of the second series and the reference pattern; classifying, in a first category, each pattern of the second series with a correlation coefficient, as an absolute value, that is less than a predetermined threshold; extracting a characteristic dimension for each pattern of the second series with a correlation coefficient, as an absolute value, that is greater than the predetermined threshold; computing an arithmetic mean and a standard deviation of the characteristic dimensions extracted in the extracting step; and classifying, in a second category, each pattern of the second series with a characteristic dimension that exhibits a deviation from the arithmetic mean that is greater than the standard deviation.

### TECHNICAL FIELD

The invention relates to the technical field of analyzing faults in a network of periodic patterns by image processing.

The invention is notably applicable when the periodic patterns are nanostructures, such as nanowires formed by epitaxy.

### PRIOR ART

Faults in nanostructures, such as, for example, nanowires or nanopyramids, can be associated with their epitaxial growth on a substrate (for example, a wafer), or with other technological steps that are applied thereto. A person skilled in the art attempts to identify the nanostructures exhibiting morphological faults (size, geometry), and attempts to have quantitative feedback concerning the quality of the epitaxy in order to determine whether the nanowires of the substrate are of sufficient quality to undergo additional technological steps of an industrial method in production mode.

A method for detecting faults that is known from the prior art, notably from document U.S. Pat. No. 9,311,698 B2, detects faults from a correlation with a reference pattern.

Such a method of the prior art, with an approach that is based on a threshold, is not entirely satisfactory for detecting faults on nanostructures. The nanostructures exhibit a dispersion, notably in the size, the shape, the contrast, the brightness, which makes it extremely difficult to precisely determine a threshold allowing reliable detection of faults. In particular, such a method of the prior art is likely to mistakenly consider that nanostructures do not include any faults, or to mistakenly consider that nanostructures include faults.

### DISCLOSURE OF THE INVENTION

The invention aims to overcome all or some of the aforementioned disadvantages. To this end, the aim of the invention is a method for classifying faults in a network to be analyzed comprising periodic patterns, the method comprising the following steps:
a) providing a digital image of a reference network, showing a first series of periodic patterns;
b) defining a reference pattern from the patterns of the first series;
c) providing a digital image of the network to be analyzed, showing a second series of periodic patterns;
d) computing a correlation coefficient between each pattern of the second series and the reference pattern;
e) classifying, in a first category, each pattern of the second series with a correlation coefficient, as an absolute value, that is less than a predetermined threshold;
f) extracting a characteristic dimension for each pattern of the second series with a correlation coefficient, as an absolute value, that is greater than the predetermined threshold;
g) computing an arithmetic mean and a standard deviation of the characteristic dimensions extracted during step f);
h) classifying, in a second category, each pattern of the second series with a characteristic dimension that exhibits a deviation from the arithmetic mean that is greater than the standard deviation.

### Definitions

The term “periodic patterns” is understood to mean patterns spaced apart at a regular distance interval (spatial period). In a perfect network, the periodic patterns are reproduced identically. In practice, the expression “identical” is understood to mean within the usual tolerances associated with the experimental manufacturing conditions, and not to the literal sense of the term.

The term “reference network” is understood to mean a network with periodic patterns that exhibit geometric characteristics that are previously known (for example, by means of measurements), and that comply with given industrial specifications.

The term “reference pattern” is understood to mean a pattern exhibiting geometric characteristics that are previously known (for example, by means of measurements), and that comply with given industrial specifications.

The term “characteristic dimension” is understood to mean a specific dimension (spatial extent) allowing a distinction to be made between the patterns of the second series for which each correlation coefficient, as an absolute value, is greater than the predetermined threshold.

Thus, such a method according to the invention allows, by virtue of steps e) and h), a dual analysis of the faults in the network to be carried out that is more reliable and robust than in the prior art. Step e) allows the patterns of the second series to be detected that are the least similar in terms of overall morphology with respect to the reference pattern, and are considered to be structural faults, classified in the first category. Step h) allows a more precise analysis by detecting the patterns of the second series that are similar in terms of overall morphology with respect to the reference pattern, but which exhibit a disparity for at least one specific dimension with respect to the reference pattern. These detected patterns of the second series are considered to be size faults, classified in the second category. Such a method according to the invention therefore allows detection errors to be significantly limited that would mistakenly determine that the nanostructures do not include any faults. This dual fault analysis allows the nature of the detected faults to be specified, and the determination of the source of these faults to be facilitated, by distinguishing, for example, the influence of epitaxy and the influence of other technological steps in the case of a network of epitaxied nanowires, with a view to improving the homogeneity and the reproducibility of the periodic patterns.

A further aim of the invention is a method for classifying faults in a set of networks to be analyzed, each comprising periodic patterns, the method comprising the following steps:
a) providing a digital image of a reference network, showing a first series of periodic patterns;
b) defining a reference pattern from the patterns of the first series;
c) providing at least one digital image of the network to be analyzed from the set, showing a second series of periodic patterns;
with the method repeating the following steps, for each digital image of each network to be analyzed from the set:
d) computing a correlation coefficient between each pattern of the second series and the reference pattern;
e) classifying, in a first category, each pattern of the second series with a correlation coefficient, as an absolute value, that is less than a predetermined threshold;
f) extracting a characteristic dimension for each pattern of the second series with a correlation coefficient, as an absolute value, that is greater than the predetermined threshold;
g) computing an arithmetic mean and a standard deviation of the characteristic dimensions extracted during step f);
h) classifying, in a second category, each pattern of the second series with a characteristic dimension that exhibits a deviation from the arithmetic mean that is greater than the standard deviation.

Thus, such a method according to the invention has the same advantages as those mentioned above. An additional advantage is to be able to iterate the dual analysis of the faults for each network of the set before engaging additional technological steps of an industrial method in production mode.

The method according to the invention can comprise one or more of the following features.

According to one feature of the invention, step f) comprises the following steps:
f₁) generating a cutting line for each pattern of the second series with a correlation coefficient, as an absolute value, that is greater than the predetermined threshold;
f₂) extracting the characteristic dimension from the cutting line.

Thus, one advantage that is provided is to be able to easily measure the characteristic dimension from an image processing operation.

According to one feature of the invention, step b) involves selecting a pattern from among the patterns of the first series, with the selected pattern defining the reference pattern.

Thus, one advantage that is provided is to allow manual selection of the reference pattern.

According to one feature of the invention, step b) comprises the following steps:
b₁) selecting an initial pattern from among the patterns of the first series;
b₂) computing a correlation coefficient between each pattern of the first series and the initial pattern;
b₃) identifying each pattern of the first series with a correlation coefficient, as an absolute value, that is greater than a predetermined threshold;
b₄) defining the reference pattern from a combination of the patterns of the first series identified during step b₃).

Thus, one advantage that is provided is to improve the reliability and the representativeness of the reference pattern.

According to one feature of the invention, the reference pattern is defined during step b) by taking a mean of the patterns of the first series.

Thus, one advantage that is provided is to improve the reliability and the representativeness of the reference pattern, when the digital image of the reference network is of good quality (low fault rate). The term “mean” is understood as a mean of the intensities of the pixels of the patterns of the first series.

According to one feature of the invention, the digital images of the reference network and of the network to be analyzed, respectively provided during steps a) and c), each comprise a set of pixels, with each pixel having an intensity;
the correlation coefficient is computed during step d) between the intensity of the pixels of each pattern of the second series and the intensity of the pixels of the reference pattern.

According to one feature of the invention, the correlation coefficient is computed during step d) in accordance with the Bravais-Pearson formula.

According to one feature of the invention, step d) is preceded by the following steps:
d₀₁) identifying the position of the patterns of the second series on the digital image of the network to be analyzed;
d₀₂) dimensioning the digital image of the network to be analyzed so that the patterns of the second series are an integer.

Thus, one advantage that is provided is to improve the reliability of the computation of the correlation coefficient by eliminating the patterns of the second series that are on the edges of the digital image of the network.

According to one feature of the invention, step d₀₁) comprises a step involving computing a correlation coefficient between the digital image of the network to be analyzed and the reference pattern.

Thus, one advantage that is provided is to be able to accurately determine the position of the patterns of the second series on the digital image of the network to be analyzed, in order to reliably count the number of patterns present on the digital image (with a maximum correlation as an absolute value).

According to one feature of the invention:
step f) comprises a step f′) involving extracting at least one additional characteristic dimension for each pattern of the second series with a correlation coefficient, as an absolute value, that is greater than the predetermined threshold;
step g) comprises a step g′) involving computing an additional arithmetic mean and an additional standard deviation of the additional characteristic dimensions extracted during step f′);
step h) comprises a step h′) involving classifying, in the second category, each pattern of the second series with an additional characteristic dimension that exhibits a deviation from the additional arithmetic mean that is greater than the additional standard deviation.

Thus, one advantage that is provided is to refine the analysis of potential faults for the patterns of the second series, which are similar in terms of overall morphology with respect to the reference pattern, but which have a potential disparity for different specific dimensions (for example, in different directions) with respect to the reference pattern, which allows a specific analysis of morphology with respect to the reference pattern.

According to one feature of the invention:
the network to be analyzed comprises nanowires, forming periodic patterns, and having a cross section in the form of a hexagon;
the characteristic dimension extracted during step f) is the dimension of one side of the hexagon.

### Definition

The term “transverse” is understood to mean a section that perpendicularly intersects the longitudinal axis of the nanowires. The longitudinal axis is the axis extending along the height of the nanowires.

According to one feature of the invention, the digital images of the reference network and of the network to be analyzed, respectively provided during steps a) and c), are digital images originating from an electron microscope, preferably a scanning electron microscope.

According to one feature of the invention, step f) is preceded by the following steps:
f₀₁) generating a histogram of the intensities of the pixels of the digital image of the network (2) to be analyzed;
f₀₂) extracting an intensity threshold of the periodic patterns of the second series from the histogram generated during step f₀₁).

Thus, one advantage that is provided by such image segmentation is to take into account the intensity threshold extracted during step f₀₂) in order to reliably extract the characteristic dimension during step f).

According to one feature of the invention:
step d) is followed by a step d′) involving counting a total number of patterns of the second series for which each correlation coefficient, as an absolute value, is greater than the predetermined threshold;
steps e) to h) are executed if the total number of patterns is greater than a predetermined value.

Thus, one advantage that is provided is to guarantee a minimum number of patterns to be analyzed during steps e) to h) in order to obtain a reliable and representative analysis from a statistical perspective.

### BRIEF DESCRIPTION OF THE DRAWINGS

Further features and advantages will become apparent from the detailed disclosure of various embodiments of the invention, with the disclosure being accompanied by examples and references to the accompanying drawings, in which:

FIG. 1 is an algorigram schematically showing a method according to the invention;

FIG. 2 is an algorigram schematically showing a method according to the invention, notably illustrating an iteration of steps d) to h) in the case of a set of networks to be analyzed;

FIG. 3 is an algorigram schematically showing a method according to the invention, notably illustrating steps f₁) and f₂);

FIG. 4 is an algorigram schematically showing a method according to the invention, notably illustrating steps b₁) to b₄);

FIG. 5 is an algorigram schematically showing a method according to the invention, notably illustrating steps d₀₁) and d₀₂);

FIG. 6 is an algorigram schematically showing a method according to the invention, notably illustrating steps f′), g′) and h′);

FIG. 7 is an algorigram schematically showing a method according to the invention, notably illustrating steps f₀₁) and f₀₂);

FIG. 8 is an algorigram schematically showing a method according to the invention, notably illustrating the step d′);

FIG. 9 is a partial schematic cross-section, showing patterns of the first series, and illustrating a first embodiment of step b);

FIG. 10 is a partial schematic cross-section, showing patterns of the first series, and illustrating a second embodiment of step b);

FIG. 11 is a partial schematic cross-section, showing patterns of the second series, and illustrating an embodiment of steps f) and f).

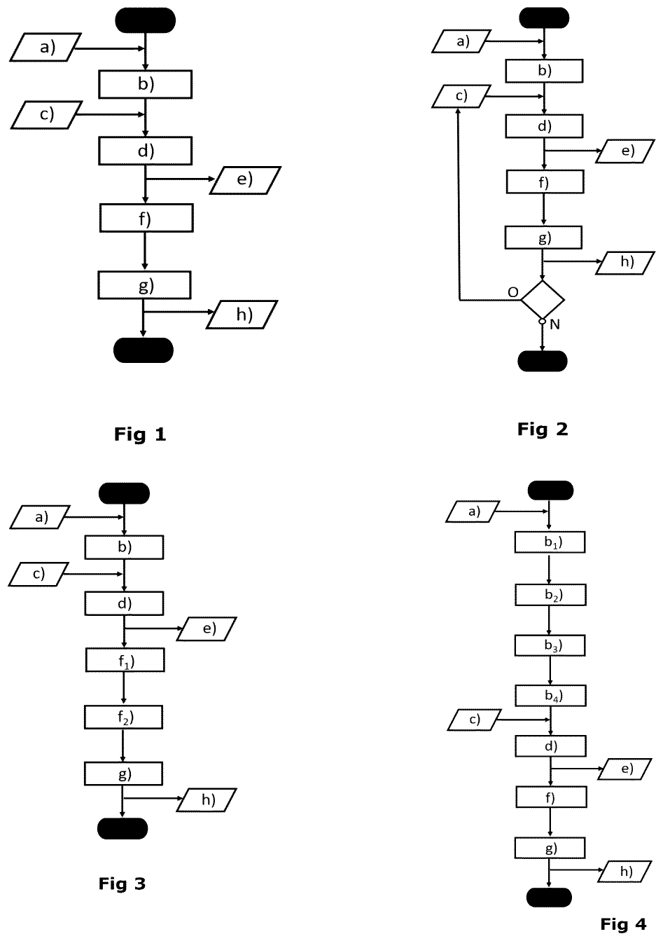

The shapes used for FIGS. 1 to 8 comply with standard ISO 5807 for algorigrams. “O” in the figures means “Yes”, i.e., that the result of the test is true. “N” in the figures means “No”, i.e., that the result of the test is false.

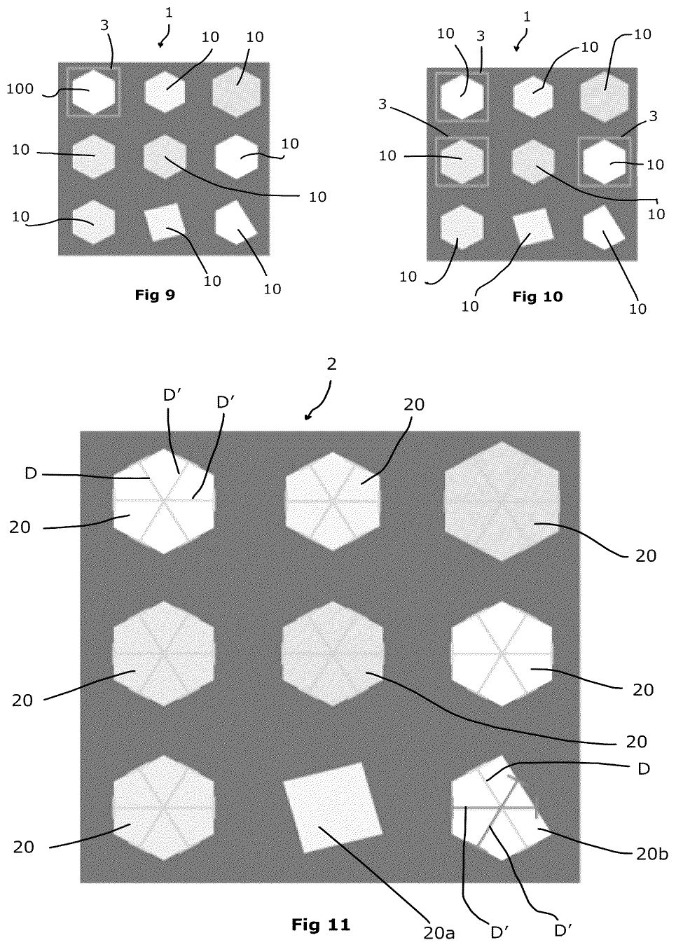

It should be noted that FIGS. 9 to 11 described above are schematic, and are not necessarily to scale for the sake of readability and in order to simplify their understanding.

### DETAILED DISCLOSURE OF THE EMBODIMENTS

Elements that are identical or that fulfil the same function will use the same reference signs for the various embodiments, for the sake of simplification.

### A Network to be Analyzed

As illustrated in FIG. 1, an aim of the invention is a method for classifying faults in a network 2 to be analyzed comprising periodic patterns 20, the method comprising the following steps:
a) providing a digital image of a reference network 1, showing a first series of periodic patterns 10;
b) defining a reference pattern 100 from the patterns 10 of the first series;
c) providing a digital image of the network 2 to be analyzed, showing a second series of periodic patterns 20;
d) computing a correlation coefficient between each pattern 20 of the second series and the reference pattern 100;
e) classifying, in a first category, each pattern 20 of the second series with a correlation coefficient, as an absolute value, that is less than a predetermined threshold;
f) extracting a characteristic dimension D for each pattern 20 of the second series with a correlation coefficient, as an absolute value, that is greater than the predetermined threshold;
g) computing an arithmetic mean and a standard deviation of the characteristic dimensions D extracted during step f);
h) classifying, in a second category, each pattern 20 of the second series with a characteristic dimension D that exhibits a deviation from the arithmetic mean that is greater than the standard deviation.

In other words, an aim of the invention is a method for detecting faults in a network 2 to be analyzed comprising periodic patterns 20, the method comprising the following steps:
a) providing a digital image of a reference network 1, showing a first series of periodic patterns 10;
b) defining a reference pattern 100 from the patterns 10 of the first series;
c) providing a digital image of the network 2 to be analyzed, showing a second series of periodic patterns 20:
d) computing a correlation coefficient between each pattern 20 of the second series and the reference pattern 100;
e) detecting each pattern 20 of the second series with a correlation coefficient, as an absolute value, that is less than a predetermined threshold;
f) extracting a characteristic dimension D for each pattern 20 of the second series with a correlation coefficient, as an absolute value, that is greater than the predetermined threshold;
g) computing an arithmetic mean and a standard deviation of the characteristic dimensions D extracted during step f);
h) detecting each pattern 20 of the second series with a characteristic dimension D that exhibits a deviation from the arithmetic mean that is greater than the standard deviation.

### Step a)

The digital image of the reference network 1, provided during step a), comprises a set of pixels, with each pixel having an intensity. By way of a non-limiting example, the digital image of the reference network 1, provided during step a), can have a TIFF (“Tag Image File Format”) format. The digital image of the reference network 1 can be a gray level image.

The digital image of the reference network 1, provided during step a), can originate from an electron microscope, preferably a scanning electron microscope.

### Step b)

As illustrated in FIG. 9, step b) can involve selecting a pattern from among the patterns 10 of the first series, with the selected pattern defining the reference pattern 100. The reference pattern 100 can be selected by a user via a graphical user interface (GUI) with a selection window 3, for example, a square selection window. The selection window 3 can have a cropping function.

As illustrated in FIG. 4, step b) can comprise the following steps:
b₁) selecting an initial pattern from among the patterns 10 of the first series;
b₂) computing a correlation coefficient between each pattern 10 of the first series and the initial pattern;
b₃) identifying each pattern 10 of the first series with a correlation coefficient, as an absolute value, that is greater than a predetermined threshold;
b₄) defining the reference pattern 100 from a combination of the patterns 10 of the first series identified during step b₃).

The patterns 10 of the first series, identified during step b₃), are shown inside selection windows 3 in FIG. 10. These patterns 10 are selected automatically, and not by the user. Step b₁) is implemented by the user, but steps b₂) to b₄) are advantageously implemented by a computer. The initial pattern, selected during step b₁) by the user, must represent a reference pattern. The patterns 10 of the first series, identified during step b₃), can represent between 0.5% and 1% of the total number of patterns 10 of the first series.

According to an alternative, the reference pattern 100 can be defined during step b) by taking a mean of the patterns 10 of the first series.

According to another alternative, it is possible to provide, during step a), several digital images of reference networks 1, each showing a first series of periodic patterns 10. Step b) can then involve defining the reference pattern 100 from a mean of the intensities of the pixels of the first series of periodic patterns 10 of the digital images of reference networks 1.

### Step c)

The digital image of the network 2 to be analyzed, provided during step c), comprises a set of pixels, with each pixel having an intensity. By way of a non-limiting example, the digital image of the network to be analyzed, provided during step c), can have a TIFF format. The digital image of the network 2 to be analyzed can be a gray level image.

The digital image of the network 2 to be analyzed, provided during step c), can originate from an electron microscope, preferably a scanning electron microscope.

As illustrated in FIG. 11, the network 2 to be analyzed can comprise nanowires, forming periodic patterns 20, and having a cross-section in the form of a hexagon.

### Step d)

Step d) is advantageously implemented by a computer.

The correlation coefficient is advantageously computed during step d) between the intensity of the pixels of each pattern 20 of the second series and the intensity of the pixels of the reference pattern 100. The correlation coefficient is advantageously computed during step d) in accordance with the Bravais-Pearson formula, which is known to a person skilled in the art.

More specifically, the correlation between the reference pattern 100 and each point of the digital image of the network 2 to be analyzed is completed by an image correlation function. This image correlation function will compare the reference pattern 100, T(xₜ, yₜ), where (xₜ, yₜ) represent the coordinates of each pixel of the reference pattern, with the image of the network 2 to be analyzed, S(x, y), where (x, y) represent the coordinates of each pixel of the image of the network 2 to be analyzed. The image correlation function involves computing the sum of the products of the coefficients of S(x, y) and T(xₜ, yₜ) for all the positions of the reference pattern 100 with respect to the image of the network 2 to be analyzed. It is then possible to renormalize the sum of the products of the coefficients of S(x, y) and T(xₜ, yₜ) in order to obtain a result ranging between −1 and 1. “−1” indicates an anti-correlation, “0” indicates a lack of correlation and “1” indicates a perfect correlation. This correlation coefficient corresponds to a linear Bravais-Pearson correlation coefficient, denoted r, between two real random variables X and Y. The linear Bravais-Pearson correlation coefficient is generally described by the following relationship:

$$r = \frac{Cov ( X , Y )}{{σ}_{X} {σ}_{Y}}$$

where:
Cov(X, Y) denotes the covariance of the variables X and Y;
σ_{X} and σ_{Y} respectively denote the standard deviation of the variable X and the standard deviation of the variable Y;
X and Y respectively correspond to the matrix of the intensities of the pixels of the image of the network 2 to be analyzed, and to the matrix of the intensities of the pixels of the reference pattern 100.

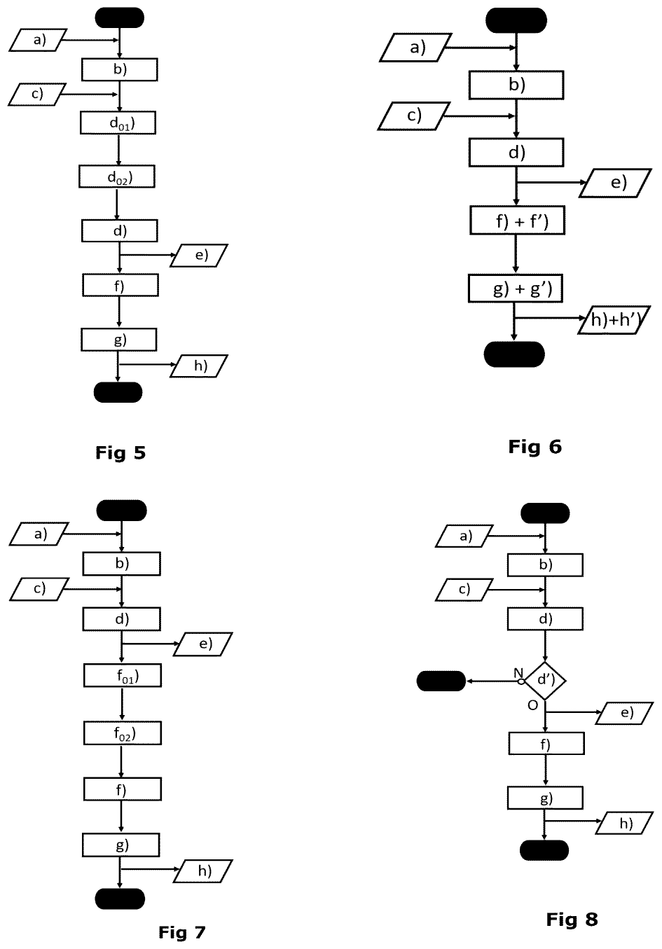

As illustrated in FIG. 5, step d) is advantageously preceded by the following steps:
d₀₁) identifying the position of the patterns 20 of the second series on the digital image of the network 2 to be analyzed;
d₀₂) dimensioning the digital image of the network 2 to be analyzed so that the patterns 20 of the second series are an integer.

Steps d₀₁) and d₀₂) are implemented by a computer. Step d₀₁) advantageously comprises a step involving computing a correlation coefficient between the digital image of the network 2 to be analyzed and the reference pattern 100.

As illustrated in FIG. 8, step d) is advantageously followed by a step d′) involving counting a total number of patterns 20 of the second series with a correlation coefficient, as an absolute value, that is greater than the predetermined threshold. Step d′) is advantageously implemented by a computer. Steps e) to h) are executed if the total number of patterns 20 is greater than a predetermined value. The conditional connection (symbolized by a rhombus) of FIG. 8 tests whether the total number of patterns 20 is greater than said predetermined value.

### Step e)

Step e) is advantageously implemented by a computer.

By way of a non-limiting example, the threshold can range between 0.6 and 0.7.

As illustrated in FIG. 11, the pattern 20a of the second series is classified in the first category. The correlation coefficient computed during step d) between the pattern 20a of the second series and the reference pattern 100 is less than the predetermined threshold.

The faults of the first category, detected during step e), can be mapped onto the digital image of the network 2 to be analyzed.

### Step f)

Step f) is advantageously implemented by a computer.

As illustrated in FIG. 3, step f) advantageously comprises the following steps:
f₁) generating a cutting line for each pattern 20 of the second series with a correlation coefficient, as an absolute value, that is greater than the predetermined threshold;
f₂) extracting the characteristic dimension D from the cutting line.

The characteristic dimension D extracted during step f) can be the dimension of one side of the hexagon. The characteristic dimension D extracted during step f) can be a distance between two parallel sides of the hexagon, or between two opposite vertices of the hexagon. The characteristic dimension D extracted during step f) can also correspond to a diameter of a circle, when the patterns 20 of the second series have a circular section. The characteristic dimension D extracted during step f) can also correspond to the dimension of a diagonal, when the patterns 20 of the second series have a square section.

As illustrated in FIG. 6, step f) advantageously comprises a step f′) involving extracting at least one additional characteristic dimension D′ for each pattern 20 of the second series with a correlation coefficient, as an absolute value, that is greater than the predetermined threshold.

As illustrated in FIG. 11, three cutting lines can be generated in order to extract a characteristic dimension D and two additional characteristic dimensions D′. A cutting line is advantageously generated by passing through the center of the hexagon. A cutting line can be generated by passing through two opposite vertices of the hexagon. A cutting line can be generated by passing through the centers of two parallel sides of the hexagon.

As illustrated in FIG. 7, step f) is advantageously preceded by the following steps:
f₀₁) generating a histogram of the intensities of the pixels of the digital image of the network 2 to be analyzed;
f₀₂) extracting an intensity threshold of the periodic patterns 20 of the second series from the histogram generated during step f₀₁).

By way of a non-limiting example, step f₀₂) can be executed by the Otsu method, which is known to a person skilled in the art. Steps f₀₁) and f₀₂) are implemented by a computer.

### Step g)

Step g) is advantageously implemented by a computer.

As illustrated in FIG. 6, step g) advantageously comprises a step g′) involving computing an additional arithmetic mean and an additional standard deviation of the additional characteristic dimensions D′ extracted during step f′).

### Step h)

Step h) is advantageously implemented by a computer.

As illustrated in FIG. 6, step h) advantageously comprises a step h′) involving classifying, in the second category, each pattern 20 of the second series with an additional characteristic dimension D′ that exhibits a deviation from the additional arithmetic mean that is greater than the additional standard deviation.

As illustrated in FIG. 11, the pattern 20b of the second series is classified in the second category. The pattern 20b of the second series has two additional characteristic dimensions D′ that exhibit a deviation from the additional arithmetic mean that is greater than the additional standard deviation.

The faults of the second category, detected during step h), can be mapped onto the digital image of the network 2 to be analyzed.

### A Set of Networks to be Analyzed

As illustrated in FIG. 2, an aim of the invention is a method for classifying faults in a set of networks 2 to be analyzed comprising each of the periodic patterns 20, the method comprising the following steps:
a) providing a digital image of a reference network 1, showing a first series of periodic patterns 10;
b) defining a reference pattern 100 from the patterns 10 of the first series:
c) providing at least one digital image of each network 2 to be analyzed from the set, showing a second series of periodic patterns 20;
   with the method repeating the following steps, for each digital image of each network 2 to be analyzed from the set:
d) computing a correlation coefficient between each pattern 20 of the second series and the reference pattern 100;
e) classifying, in a first category, each pattern 20 of the second series with a correlation coefficient, as an absolute value, that is less than a predetermined threshold;
f) extracting a characteristic dimension D for each pattern of the second series with a correlation coefficient, as an absolute value, that is greater than the predetermined threshold;
g) computing an arithmetic mean and a standard deviation of the characteristic dimensions D extracted during step f);
h) classifying, in a second category, each pattern 20 of the second series with a characteristic dimension D that exhibits a deviation from the arithmetic mean that is greater than the standard deviation.

In other words, an aim of the invention is a method for detecting faults in a set of networks 2 to be analyzed comprising each of the periodic patterns 20, the method comprising the following steps:
a) providing a digital image of a reference network 1, showing a first series of periodic patterns 10;
b) defining a reference pattern 100 from the patterns 10 of the first series;
c) providing at least one digital image of the network 2 to be analyzed from the set, showing a second series of periodic patterns 20;
   with the method repeating the following steps, for each digital image of each network 2 to be analyzed from the set:
d) computing a correlation coefficient between each pattern 20 of the second series and the reference pattern 100;
e) detecting each pattern 20 of the second series with a correlation coefficient, as an absolute value, that is less than a predetermined threshold;
f) extracting a characteristic dimension D for each pattern 20 of the second series with a correlation coefficient, as an absolute value, that is greater than the predetermined threshold;
g) computing an arithmetic mean and a standard deviation of the characteristic dimensions D extracted during step f);
h) detecting each pattern 20 of the second series with a characteristic dimension D that exhibits a deviation from the arithmetic mean that is greater than the standard deviation.

The technical features described above for steps a) to h) apply to these aims of the invention. The conditional branch (symbolized by a rhombus) of FIG. 2 tests for the presence of a digital image of a network 2 to be analyzed.

The invention is not limited to the disclosed embodiments. A person skilled in the art is able to consider their technically operative combinations, and to replace them with equivalents.

1. A method for classifying faults in a network to be analyzed comprising periodic patterns, the method comprising:
a) providing a digital image of a reference network, showing a first series of periodic patterns;
b) defining a reference pattern from the patterns of the first series;
c) providing a digital image of the network to be analyzed, showing a second series of periodic patterns;
d) computing a correlation coefficient between each pattern of the second series and the reference pattern;
e) classifying, in a first category, each pattern of the second series with a correlation coefficient, as an absolute value, that is less than a predetermined threshold;
f) extracting a characteristic dimension for each pattern of the second series with a correlation coefficient, as an absolute value, that is greater than the predetermined threshold;
g) computing an arithmetic mean and a standard deviation of the characteristic dimensions extracted during step f); and
h) classifying, in a second category, each pattern of the second series with a characteristic dimension that exhibits a deviation from the arithmetic mean that is greater than the standard deviation.

2. A method for classifying faults in a set of networks to be analyzed each comprising periodic patterns, the method comprising the following steps:
a) providing a digital image of a reference network, showing a first series of periodic patterns;
b) defining a reference pattern from the patterns of the first series; and
c) providing at least one digital image of each network to be analyzed from the set, showing a second series of periodic patterns,
wherein the method further comprises repeating the following steps, for each digital image of each network to be analyzed from the set:
d) computing a correlation coefficient between each pattern of the second series and the reference pattern;
e) classifying, in a first category, each pattern of the second series with a correlation coefficient, as an absolute value, that is less than a predetermined threshold;
f) extracting a characteristic dimension for each pattern of the second series with a correlation coefficient, as an absolute value, that is greater than the predetermined threshold;
g) computing an arithmetic mean and a standard deviation of the characteristic dimensions extracted during the step f); and
h) classifying, in a second category, each pattern of the second series with a characteristic dimension that exhibits a deviation from the arithmetic mean that is greater than the standard deviation.

3. The method as claimed in claim 1, wherein the step f) further comprises:
f₁) generating a cutting line for each pattern of the second series with a correlation coefficient, as an absolute value, that is greater than the predetermined threshold; and
f₂) extracting the characteristic dimension from the cutting line.

4. The method as claimed in claim 1, wherein the step b) comprises selecting a pattern from among the patterns of the first series, with the selected pattern defining the reference pattern.

5. The method as claimed in claim 1, wherein the step b) comprises:
b₁) selecting an initial pattern from among the patterns of the first series;
b₂) computing a correlation coefficient between each pattern of the first series and the initial pattern;
b₃) identifying each pattern of the first series with a correlation coefficient, as an absolute value, that is greater than a predetermined threshold; and
b₄) defining the reference pattern from a combination of the patterns of the first series identified during the step b₃).

6. The method as claimed in claim 1, wherein the reference pattern is defined during the step b) by taking a mean of the patterns of the first series.

7. The method as claimed in claim 1, wherein the digital images of the reference network and of the network to be analyzed, respectively provided during the steps a) and c), each comprise a set of pixels, with each pixel having an intensity; and
the correlation coefficient is computed during the step d) between the intensity of the pixels of each pattern of the second series and the intensity of the pixels of the reference pattern.

8. The method as claimed in claim 1, wherein the correlation coefficient is computed during the step d) in accordance with the Bravais-Pearson formula.

9. The method as claimed in claim 1, wherein the step d) is preceded by the following steps:
d₀₁) identifying the position of the patterns of the second series on the digital image of the network to be analyzed; and
d₀₂) dimensioning the digital image of the network to be analyzed so that the patterns of the second series are an integer.

10. The method as claimed in claim 9, wherein the step d₀₁) further comprises computing a correlation coefficient between the digital image of the network to be analyzed and the reference pattern.

11. The method as claimed in claim 1, wherein:
the step f) further comprises a step f′) including extracting at least one additional characteristic dimension for each pattern of the second series with a correlation coefficient, as an absolute value, that is greater than the predetermined threshold;
the step g) further comprises a step g′) including computing an additional arithmetic mean and an additional standard deviation of the additional characteristic dimensions extracted during the step f′); and
the step h) further comprises a step h′) including classifying, in the second category, each pattern of the second series with an additional characteristic dimension that exhibits a deviation from the additional arithmetic mean that is greater than the additional standard deviation.

12. The method as claimed in claim 1, wherein:
the network to be analyzed comprises nanowires, forming periodic patterns, and having a cross section in the form of a hexagon; and
the characteristic dimension extracted during the step f) is the dimension of one side of the hexagon.

13. The method as claimed in claim 1, wherein the digital images of the reference network and of the network to be analyzed, respectively provided during the steps a) and c), are digital images originating from an electron microscope.

14. The method as claimed in claim 1, wherein the step f) is preceded by the following steps:
f₀₁) generating a histogram of the intensities of the pixels of the digital image of the network to be analyzed; and
f₀₂) extracting an intensity threshold of the periodic patterns of the second series from the histogram generated during the step f₀₁).

15. The method as claimed in claim 1, wherein:
the step d) is followed by a step d′) including counting a total number of patterns of the second series for which each correlation coefficient, as an absolute value, is greater than the predetermined threshold; and
the steps e) to h) are executed if the total number of patterns is greater than a predetermined value.
